(19) United States
(12) Patent Application Publication
(10) Pub. No.: US 2010/0232267 A1
(43) Pub. Date: Sep. 16, 2010

(54) INFORMATION RECORDING APPARATUS, METHOD OF OPC PROCESS FOR MULTILAYER INFORMATION RECORDING MEDIUM, AND PROGRAM

(76) Inventors: Ryo Harada, Tokorozawa-Shi (JP); Shin Akabane, Tokorozawa-shi (JP); Tsutomu Satake, Tokorozawa-shi (JP)

Correspondence Address: YOUNG & THOMPSON, 209 Madison Street, Suite 500, Alexandria, VA, 22314, US

(21) Appl. No.: 12/278,805

(22) PCT Filed: Jan. 18, 2007
(86) PCT No.: PCT/JP2007/050668

§ 371 Date: Aug. 8, 2008

(30) Foreign Application Priority Data
Feb. 8, 2006 (JP) 2006-030517

(51) Int. Cl. G11B 7/00

(52) U.S. Cl. 369/47.5; G9B/7

(57) ABSTRACT

The invention is directed to provide an information recording apparatus having an adjusting process device which performs adjusting processes including an OPC process for optimizing a recording power for each of recording layers on a multilayer information recording medium, and an information recording device which performs an information recording process for each of the recording layers based on a result of the adjusting processes for each of the recording layers. The adjusting process device includes an initial adjusting process device which performs the adjusting processes at a start of information recording with the information recording device only for a start recording layer having the first recording start address, and an intermediate adjusting process device which performs the adjusting processes during information recording process with the information recording device for a recording layer other than the start recording layer.

### TECHNICAL FIELD

The present invention relates to an information recording apparatus to perform an OPC process for optimizing a recording power for respective recording layers of a multilayer information recording medium, a method of the OPC process for the multilayer information recording medium, and a program.

### BACKGROUND ART

Generally, an information recording apparatus which records information on an information recording medium such as a DVD and a CD performs an OPC (Optimum Power Calibration) process for optimizing a recording power (an output of a laser beam) at a start of information recording. In recent years, an information recording medium with a multilayer structure having a plurality of recording layers for improving recording capacity is known. When the OPC process is performed to the information recording medium with the multilayer structure (hereinafter, referred to as a “multilayer information recording medium”), there is a possibility of a longer process time (an initialization time at the start of information recording) because the recording power needs to be optimized per recording layer.

Therefore, to shorten a time needed for the OPC process, one of the techniques is proposed in which the OPC process of a second recording layer is omitted by calculating an optimum output value of the laser beam for the second recording layer based on an OPC process result of a first recording layer (the optimum output value of the laser beam) and a ratio of deviation of output patterns from a light receiving element when receiving reflective lights from the first recording layer and the second recording layer (for example, Patent Document 1). [Patent Document 1] JP-A-2005-267809

### DISCLOSURE OF THE INVENTION

### Problems to be Solved

However, the method disclosed in the Patent Document 1 above calculates the optimum output value of the laser beam for the second recording layer. When the method is compared with a method in which the optimum output value of the laser beam is set using a result of the OPC process performed practically for the second recording layer, the method in the Document 1 has less reliability. Also, adjusting processes (such as a servo-gain adjusting process, etc) are necessary for the second recording layer. Therefore, it is practically impossible to reduce the initialization time at the start of information recording to a same extent as that of a single layer information recording medium.

Accordingly, an object of the invention is to provide an information recording apparatus which is capable of shortening an initialization time at a start of information recording to a same extent as that of a single layer information recording medium, while keeping a recording power for each of recording layers properly when information is recorded on a multilayer information recording medium, a method of an OPC process for the multilayer information recording medium, and a program.

### Means to Solve the Problems

An information recording apparatus of the invention has an adjusting process device which performs adjusting processes including an OPC process for optimizing a recording power for each of recording layers on a multilayer information recording medium, and an information recording device which performs an information recording process for each of the recording layers based on a result of the adjusting processes for each of the recording layers. The adjusting process device includes an initial adjusting process device which performs the adjusting processes at a start of information recording with the information recording device only for a start recording layer having a first recording start address, and an intermediate adjusting process device which performs the adjusting processes during information recording process with the information recording device for a recording layer other than the start recording layer.

With this configuration, when the adjusting processes including the OPC process for each of the recording layers of the multilayer information recording medium, it is possible to shorten an initialization time to a same extent as that of a single layer information recording medium, because the adjusting processes are performed only for a start recording layer having a first recording start address at a start of information recording and are performed for other layers during the information recording process. As the adjusting processes are practically performed for the other layers other than the start recording layer, it is reliable for setting an optimum recording power for each of the recording layers. Note that the “multilayer information recording medium” means an information recording medium with a multilayer structure having a plurality of recording layers, and that the “OPC process” means an Optimum Power Calibration process, that is, a process for optimizing a recording power for each of the recording layers of the multilayer information recording medium.

It is preferable that, in the above information recording apparatus, the information recording device performs the information recording process with an intermittent motion repeating a real recording motion mode and a power save mode, and the intermittent adjusting process device performs the adjusting processes in the power save mode.

With this configuration, the adjusting processes can be performed for recording layers other than the start recording layer without lowering a recording speed, because the adjusting processes are performed in the power save mode of the intermittent motion of a general information recording method in the information recording apparatus such as a DVD recorder and a DVD camcorder. Note that the “real recording motion mode” means a state in which a recording motion is practically performed for the recording layers, and the “power save mode” means a state in which the recording motion is not practically performed even in the information recording process.

It is preferable that, in the above information recording apparatus, the intermediate adjusting process device interrupts the adjusting processes to switch the information recording device to the real recording motion mode in a case that the information recording device needs to be switched to the real recording motion mode during the adjusting processes, and performs incomplete adjusting processes when the information recording device is switched to the power save mode again.

With this configuration, the recording motion is performed by interrupting the adjusting processes once recording data is written in a buffer even during the adjusting processes. Therefore, the recording speed is not affected even if the adjusting processes are not complete in one power save mode. Shortly, all the adjusting processes can be performed without lowering the recording speed in a case a number of processes including the OPC process and a servo gain adjustment are necessary as the adjusting processes.

It is preferable that, in the above information recording apparatus, the intermediate adjusting process device performs partial adjusting processes divided into a plurality of processes from the adjusting processes when the information recording device is switched from the real recording motion mode to the power save mode.

With this configuration, the adjusting processes can be easily controlled by dividing the adjusting processes into a plurality of adjusting processes which are feasible in one power save mode and by performing each of them in the power save mode. For example, in a case the servo gain adjustment and the OPC process are performed as the adjusting processes, the servo gain adjustment is performed in the first power save mode and the OPC process is performed in the next power save mode.

A method of an OPC process for a multilayer information recording medium of the invention performs the OPC process for optimizing a recording power for each of recording layers on the multilayer information recording medium, the OPC process being performed during an information recording process for a recording layer other than a start recording layer having a first recording start address.

With this configuration, it is possible to shorten an initialization time at a start of information recording with an amount of time for the OPC process, because the OPC process is performed for a start recording layer having the first recording start address and is performed for the other recording layers during the information recording process. Also, the adjusting processes are practically performed for recording layers other than the start recording layer. Therefore, it is reliable for setting an optimum recording power for each of the recording layers. Note that the “multilayer information recording medium” means an information recording medium with a multilayer structure having a plurality of recording layers, and that the “OPC process” means an Optimum Power Calibration process, that is, a process for optimizing a recording power for each of the recording layers of the multilayer information recording medium.

A program according to the invention features the capability of causing a computer to function as each of the devices included in the information recording apparatus described above.

Using the program, the information recording apparatus can be obtained in which the initialization time at a start of information recording can be shortened to a same extent as that of a single layer information recording medium, while keeping a recording power properly for each of the recording layers when information recording is performed in the multilayer information recording medium.

### BRIEF DESCRIPTION OF THE DRAWINGS

FIG. 1 shows a block diagram of a DVD camcorder according to one embodiment of the invention.

FIG. 2 is a diagram showing a layer structure of a multilayer optical disk.

FIG. 3 is a functional block diagram of the DVD camcorder.

FIG. 4 is a flowchart showing an information recording process.

FIG. 5 is a flowchart following to FIG. 4.

### REFERENCE NUMERALS

1 DVD camcorder
10 laser beam
12 optical pickup
20 driving control system
30 recording/playing signal process system
40 front end controller
91a first recording layer (L0 layer)
91b second recording layer (L2 layer)
110: adjusting process device
111: initial adjusting process device
112: intermediate adjusting process device
120: information recording device
D: multilayer optical disk

### BEST MODES FOR CARRYING OUT THE INVENTION

An information recording apparatus according to one embodiment of the invention, a method of an OPC process of a multilayer information recording medium, and a program will hereinafter be described in detail with reference to accompanying drawings. The invention is such that, when various adjusting processes including the OPC (Optimum Power Calibration) process for optimizing a recording power are performed, the adjusting processes are performed only for a start recording layer having the first recording start address at a start of information recording, and are performed for the other recording layers during an information recording process, thereby, obtaining an operation and an advantage that the initialization time at the start of information recording can be shortened with an amount of adjusting process time for the other recording layers. The information recording apparatus of the invention will be explained with an example of a DVD camcorder provided therein.

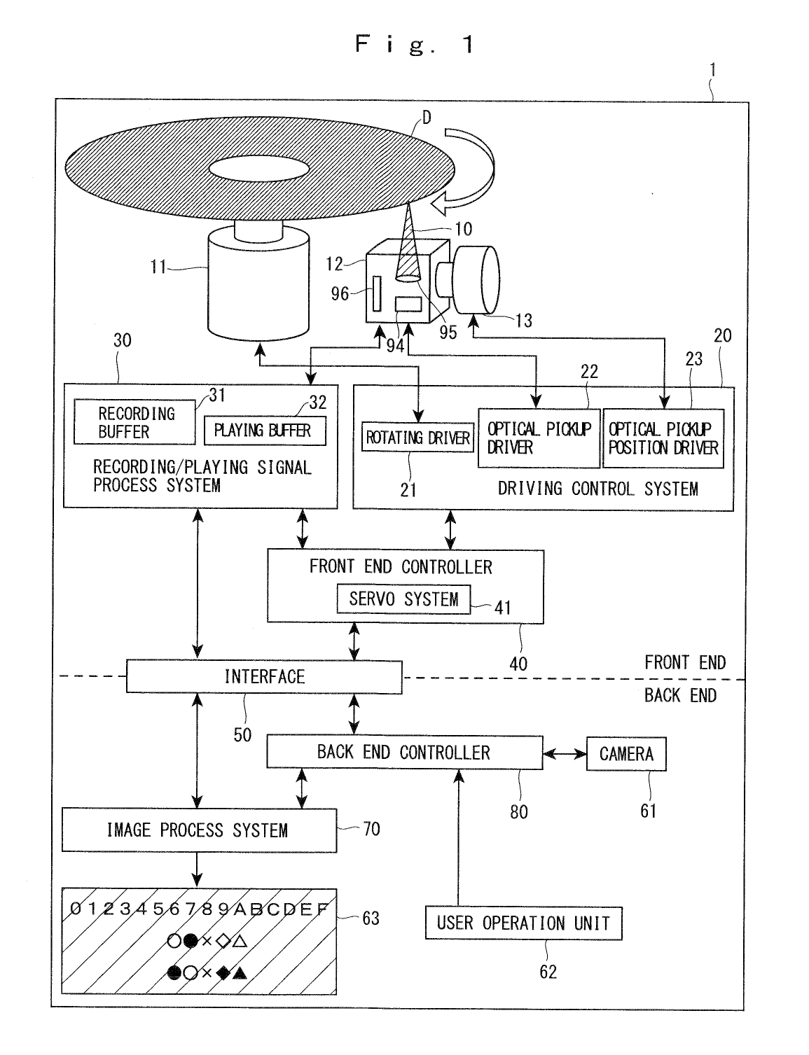

FIG. 1 is a block diagram of the DVD camcorder 1 according to one embodiment of the invention. As shown in FIG. 1, the DVD camcorder 1 has, at its' front end side, a spindle motor 11 which rotates a multilayer information recording medium having a plurality of recording layers (referred to as a “multilayer optical disk” hereinafter) D, an optical pickup 12 which reads/write information by emitting a laser beam 10 on the multilayer optical disk D, a tracking motor (a moving mechanism system) 13 which moves the optical pickup 12 to face a proper position on the multilayer optical disk D, a driving control system 20 which drives the spindle motor 11, the optical pickup 12 and the tracking motor 13, a recording/playing signal process system 30 which performs an information recording process and a playing process, and a front end controller 40 which controls the driving control system 20 and the recording/playing signal process system 30 integrally.

The camcorder 1 further has, at its back end side, a camera 61 which takes images of an object, a user operation unit 62 by which a user operates various operations, a liquid crystal display 63 which displays video during taking images or video (images) read from the multilayer optical disk D, an image process system 70 which performs an imaging process for the video (images) displayed on the liquid crystal display 63, and a back end controller 80 which controls the user operation unit 62, the image process system 70 and the camera 61 integrally. The recording/playing signal and various control data are input and output between the front end side and the back end side via an interface 50 provided therebetween.

The optical pickup 12 has a laser element 94 which emits the laser beam 10, an object lens 95 which accumulates the laser beam 10 at a read out position or a write in position on the multilayer optical disk D, and a light receiving element 96 which receives a reflected light of the laser beam 10. The light receiving element 96 transforms the received reflected light from each of the recording layers into an electrical signal and outputs to the recording/playing signal process system 30.

The driving control system 20 has a rotating driver 21 which drives the spindle motor 11, an optical pickup driver 22 which drives the optical pickup 12, and an optical pickup position driver 23 which drives the tracking motor 13. The recording/playing signal process system 30 has a recording buffer 31 which stores recording signal (a recording data) to be recorded on the multilayer optical disk D and a playing buffer 32 which stores playing signal (a playing data) read out from the multilayer optical disk D.

The front end controller 40 has a servo system 41 which controls the driving control system 20 described above. The servo system 41 controls the rotating driver 21 (the spindle motor 11) based on a position of the optical pickup 12 and rotates the multilayer optical disk D at an optimum number of rotation. Also, the front end controller 40 controls the optical pickup driver 22 (the optical pickup 12) and the optical pickup position driver 23 (the tracking motor 13) and performs an adjustment (a servo gain adjustment) such as focusing and tracking for an optical spot position and a seek control which moves the optical pickup 12 to a desired track. Further, the front end controller 40 writes recording marks while varying an output power of the laser beam 10 on test regions of the multilayer optical disk D, verifies recording quality per output of the laser beam 10 based on read out results of the recording marks, and sets an optimum recording power based on the verifications (referred to as an “OPC process” for simplification, hereinafter).

A back end controller 80 generates video signal based on an imaging data input from the camera 61, and outputs the video signal to at least one of the interface 50 or the image process system 70 based on an instruction from the user operation unit 62. When a playing data of the multilayer optical disk D is input from the front end side via the interface 50, the data is output to the image process system 70. The image process system 70 performs a VTR signal process and a decode process for the input video signal and the playing data.

The recording/playing process of the DVD camcorder 1 will be briefly explained. When the video signal taken with the camera 61 is input to the front end side via the back end controller 80 and the interface 50 based on a recording instruction from the user operation unit 62, the front end controller 40 controls the driving control system 20 to move the optical pickup 12 to a proper position, and performs various adjusting processes including the OPC process for optimizing the recording power for the start recording layer (the recording layer having the first recording start address) of multilayer optical disk D. The front end controller 40 inputs the video signal input from the back end side to the recording/playing signal process system 30. The recording/playing signal process system 30 transforms the input video signal from the front end controller 40 to a recording data for controlling ON/OFF of the laser, stores in the recording buffer 31 temporarily, and inputs to the optical pickup 12 sequentially.

On the other hand, when a playing instruction is issued from the user operation unit 62, the front end controller 40 controls the driving control system 20, and makes the optical pickup 12 access to a desired address to be played. The playing signal read out with weak laser power (around one tenth of recording) from the optical pickup 12 is processed with a digital signal process by the recording/playing signal process system 30. The front end controller 40 displays a playing data after the digital signal process on the liquid crystal display 63 via the interface 50, the back end controller 80 and the image process system 70, or outputs to an external apparatus via an external interface (not shown).

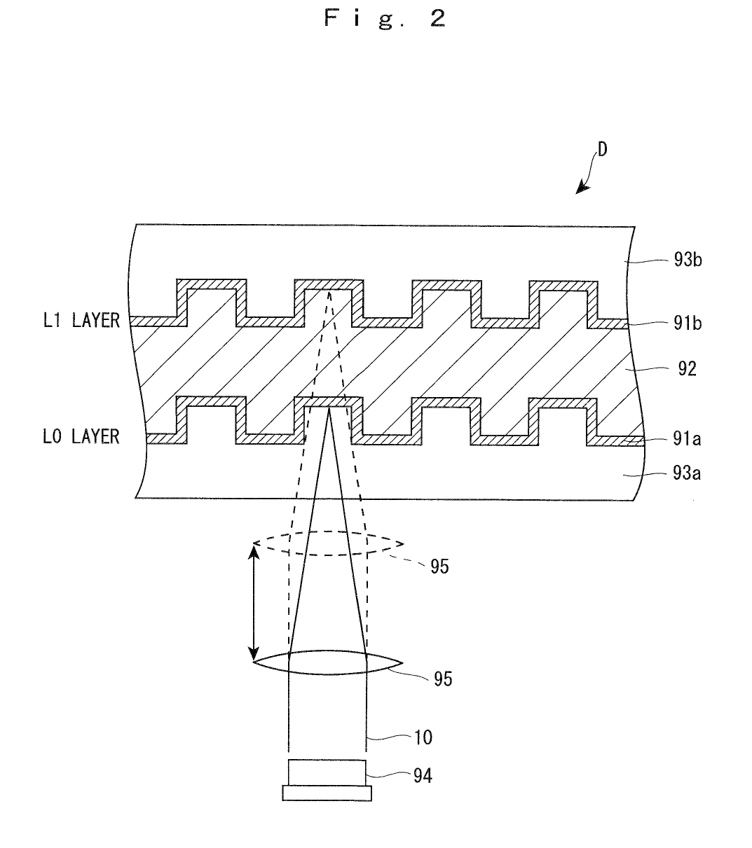

Referring to FIG. 2, the layer structure of the multilayer optical disk D will be explained. An optical disk with a dual layer structure having two recording layers 91a and 91b will be exemplified hereinafter. The multilayer optical disk D is laminated with a base layer 93a, the first recording layer (L0 layer) 91a, an intermediate layer (a spacer layer) 92, the second recording layer (L1 layer) 91b and a base layer 93b, from an emitting side of the laser beam 10. The first recording layer 91a is formed on a translucent reflecting film to reflect half and to transmit half of the laser beam 10. The second recording layer 91b is formed on a total reflecting film to reflect the emitted laser beam 10 entirely. The intermediate layer 92 is formed with a material with high transmittance rate such as a transparent light curing resin.

The recording and playing of information to/from each of the recording layers (L0 layer and L1 layer) 91a, 91b are performed by moving the objective lens 95 which converges the laser beam 10 closely to or away from the multilayer optical disk D (refer to an arrow in FIG. 2) so as to converge a focal point of the laser beam 10 on the first recording layer 91a or the second recording layer 91b.

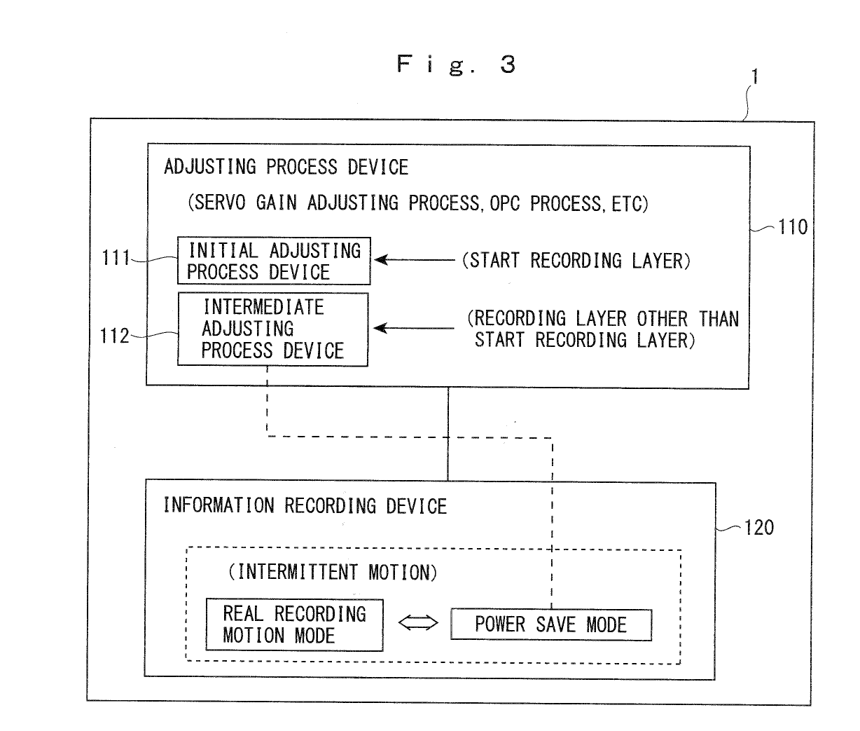

A control structure for the DVD camcorder 1 will be explained with reference to a functional block diagram shown in FIG. 3. The control system of the DVD camcorder 1, for each of the recording layers 91a and 91b of the multilayer optical disk D, is divided into an adjusting process device 110 which performs various adjusting processes including the above OPC process, and an information recording device 120 which performs an information recording process for each of the recording layers 91a, 91b base on results of adjusting processes by the adjusting process device 110.

The adjusting process device 110 has an initial adjusting process device 111 which performs the adjusting processes only for the start recording layer having the first recording start address, and an intermediate adjusting process device 112 which performs the adjusting processes for a recording layer other than the start recording layer. In short, in case of the multilayer optical disk D with the dual layer structure shown in FIG. 2, when L0 layer 91a has the first recording start address, the initial adjusting process device 111 performs the adjusting processes for L0 layer 91a, and the intermediate adjusting process device 112 performs the adjusting processes for L1 layer 91b.

Each of the adjusting process devices 111, 112 performs in common processes corresponding to adjusting processes normally performed at the start of information recording on the multilayer optical disk D such as an initialization process for the optical pickup 12 including the servo gain and adjusting processes for emitting timing as well as the OPC process, but the timings for performing the processes are different. As concretely described later, the initial adjusting process device 111 performs the adjusting processes at the start of information recording by the information recording device 120, and the intermediate adjusting process device 112 performs the adjusting processes during information recording process by the information recording device 120, respectively.

On the other hand, the information recording device 120 performs information recording process with an intermittent motion repeating a “real recording motion mode” and a “power save mode” in a couple of seconds or in tens of seconds. With the intermittent motion, it is possible to reduce electrical consumption of the DVD camcorder 1. Note that the “real recording motion mode” means a state in which a recording is performed practically on each of the recording layers 91a and 91b, and the “power save mode” means a state in which emitting of the laser beam 10 is completely interrupted and the multilayer optical disk D is merely rotated (the spindle motor 11 and an actuator for controlling the tracking motor 13 do not function when they are not necessary).

The intermediate adjusting process device 112 performs the adjusting processes during the information recording process by the information recording device 120 described above and uses the “power save mode” of the intermittent motion. Usually, the “power save mode” continues more than five seconds when switched to the power save mode. Also the adjusting processes need tens of seconds per recording layer 91. Therefore, the adjusting processes for the recording layer other than the start recording layer, that is, the intermediate adjusting processes are performed in a couple of power save modes.

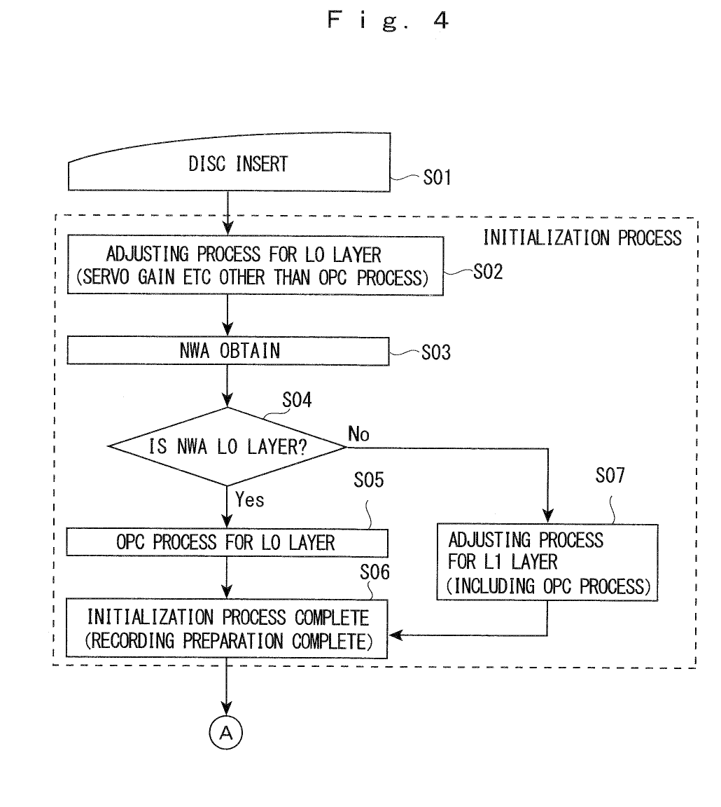

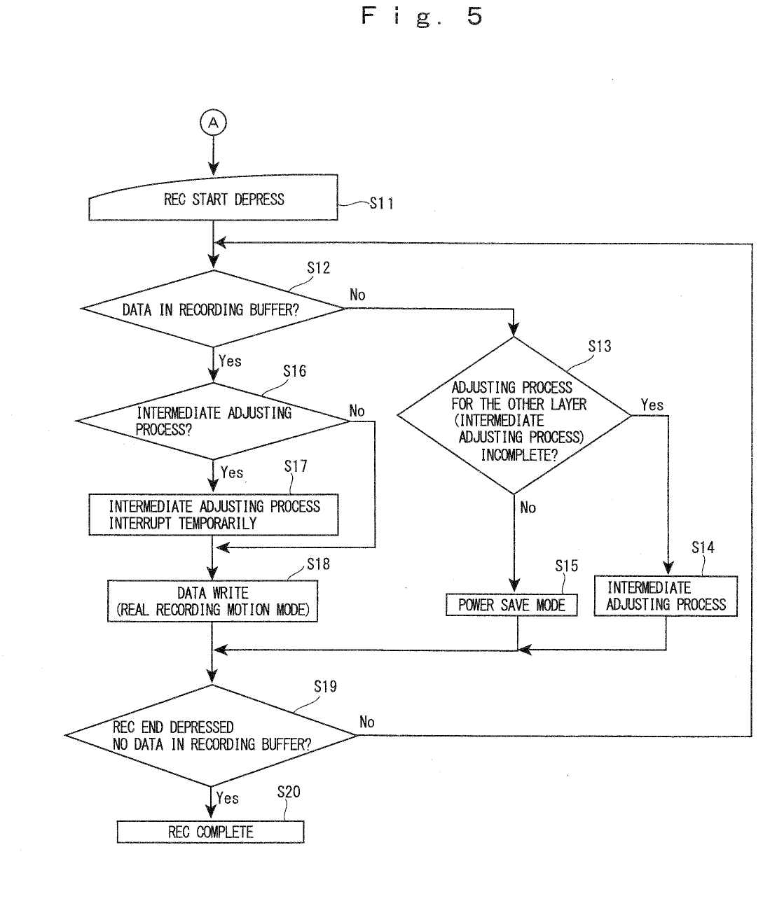

A series of the information recording process (especially, the initial adjusting processes and the intermediate adjusting processes by the above adjusting process device 110) will be described with reference to FIGS. 4 and 5. When the multilayer optical disk D is inserted in the DVD camcorder 1 by the user (S01), the adjusting processes for L0 layer 91a are performed (S02). Here, processes such as servo gain adjustment other than the OPC process are performed. If the multilayer optical disk D has equal to or more than three layers, the closest recording layer to the emitting side of the laser beam 10 is processed with the adjusting processes in S02.

Then, a next recording start address (NWA: Next Writable Address) which is written in an inner circumferential lead-in area of the multilayer optical disk D is obtained (read out) (S03), and it is determined if the start recording layer having the NWA is L0 layer 91a (S04). If the start recording layer is L0 layer 91a (S04: Yes), the OPC process for L0 layer 91a is performed (S05). Shortly, If the start recording layer is L0 layer 91a, then, the initial adjusting processes are performed (refer to the initial adjusting process device 11 and FIG. 3) with the adjusting processes in S02 and the OPC process in S05, and the initialization process for recording preparation is completed (S06) along with the completion of the process of S05.

On the other hand, in S04, if the start recording layer is not L0 layer 91a (that is, the start recording layer is L1 layer 91b) (S04: No), then, the adjusting processes are performed for L1 layer 91b (S07). Here, the adjusting processes including the servo gain adjustment and the OPC process are performed. Accordingly, if the start recording layer is L1 layer 91b, all of the initial adjusting processes are performed in S07 (refer to the initial adjusting process device 111 and FIG. 3). The initialization process for recording preparation is completed (S06) along with the process completion in S07.

Thus, according to the embodiment, regardless that the initial recording start address is in L0 layer 91a or in L1 layer 91b, the adjusting processes are performed for only one recording layer having the first recording start address as the initial adjusting processes (the initialization process), thereby it is possible to shorten a user wait time till the recording is begun to a same extent as that of an optical disk with a single layer structure.

Note that, in place of performing the adjusting processes (processes such as a servo gain adjustment other than the OPC process) for L0 layer 91a in S02, all of the initial adjusting processes (adjusting processes including the servo gain adjustment and the OPC process) may be performed in S05 while default values are set temporarily. According to this structure, even if the start recording layer is L1 layer 91b (S04: No), time needed for the initialization process can be further shortened.

Next, a flowchart in FIG. 5 will be explained. After the completion of the initialization process shown in FIG. 4, when starting for recording is instructed by the user depressing a Rec start button (S11), it is determined if there is a recording data in the recording buffer 31 (refer to FIG. 1) (S12). In a normal process (in a case that the intermediate adjusting processes are not performed during the information recording process), if the data is in the recording buffer 31, the real recording motion mode is used, whereas if the data is not in the recording buffer 31, the power save mode is used.

However, in the embodiment, when the recording buffer 31 does not contain the data (S12: No), it is determined if the adjusting processes for the other layer (intermediate adjusting processes) are incomplete (S13). Accordingly, in S04 in FIG. 4, if it is determined that NWA is L0 layer 91a, L1 layer 91b corresponds to the “other layer” in S13, and it is determined if the adjusting processes for L1 layer 91b are incomplete. On the other hand, if it is determined that NWA is L1 layer 91b, L0 layer 91a corresponds to the “other layer” in S13, and it is determined if the adjusting processes for L0 layer 91a are incomplete.

When the adjusting processes for the other layer are incomplete (S13: Yes), the incomplete intermediate adjusting processes are performed (S14). For example, when a routine is firstly performed after the Rec start button is depressed, the first process of the adjusting processes is performed in S14. In other words, when ten processes of the adjusting processes are performed per recording layer, the adjusting processes are performed from the first process, and each process of the adjusting processes is performed sequentially if there is no need to data recording. In this regard, when L0 layer 91a corresponds to the other layer, the OPC process is performed in S14 because processes other than the OPC process have already been performed in S02 in FIG. 4.

Also, in S13, the adjusting processes for the other layer are complete (S13: No), the power save mode will be used (S15, the information recording device 120). That is, after adjusting processes for all of the recording layers of the multilayer optical disk D are complete, if the data is not in the recording buffer 31 (S12: No), the power save mode will be used as usual.

On the other hand, in S12, if the data is contained in the recording buffer 31 (S12: Yes), it is determined if the intermediate adjusting processes (processes for the other layer) are being performed (S16). If the intermediate adjusting processes are being performed (S16: Yes), the intermediate adjusting processes are interrupted temporarily (S17). Accordingly, if the information recording device 120 needs to be switched to the real recording motion mode while the intermediate adjusting processes are being performed, the intermediate adjusting process device 112 interrupts the intermediate adjusting processes and data recording is performed by the information recording device 120 (S18). When the intermediate adjusting processes are interrupted, it is determined that the intermediate adjusting processes are incomplete when the next routine is performed (S13: Yes) and the incomplete intermediate adjusting processes are performed.

After a predetermined time passes in S14, S15 and S19, end of recording is instructed by the user depressing a Rec end button (refer to the user operation unit 62 in FIG. 1) and it is determined if the data is out of the recording buffer 31 (S19). When the Rec end button is depressed and the recording buffer 31 does not contain the data (S19: Yes), the information recording process is completed (S20). Also, when the Rec end button is not depressed or the recording buffer 31 still contains the data (S19: No), steps S12-S18 above are repeated.

As described above, according to the embodiment, when various adjusting processes including the OPC process are performed for each of the recording layers of the multilayer optical disk D, the adjusting processes are performed only for the start recording layer having the first recording start address at the start of information recording, and the adjusting processes are preformed for the other recording layers during the information recording process. Therefore, the initialization time at the start of information recording can be shortened to a same extent as that of the optical disk with a single structure optical disk. Also, the adjusting processes are practically performed for recording layers other than the start recording layer, thereby it is reliable for setting an optimum recording power for each of the recording layers.

As the intermediate adjusting processes are performed utilizing the “power save mode” of intermittent motion, a recording speed will not be lowered. As the intermittent motion is a general information recording method in an information recording apparatus such as a DVD recorder and a DVD camcorder, a versatility of the invention can be improved.

If the information recording device 120 needs to switched to the real recording motion mode when the intermediate adjusting processes with the intermediate adjusting process device 120 are being performed, the information recording device 120 interrupts the adjusting processes temporarily and uses the real recording motion mode. When the power save mode is used again, the intermediate adjusting process device 112 performs the incomplete adjusting processes. Therefore, even if the adjusting processes are not complete in one power save mode, the recording speed is not affected. Shortly, it is possible to perform all processes without slowing the recording speed even in a case that a number of processes including the OPC process and the servo gain adjustment are needed as adjusting processes.

In the above case, when the information recording device 120 is switched to the real recording motion mode, the intermediate adjusting processes are interrupted temporarily for switching to the real recording motion mode. Also, it is possible to divide the intermediate adjusting processes into a plurality of partial adjusting processes (processes which are feasible in one power save mode), each of the partial adjusting processes may be performed in each of the power save mode. For example, when the servo gain adjustment and the OPC process are performed as the partial adjusting processes, the servo gain adjustment is performed in the first power save mode and the OPC process is performed in the next power save mode. According to this structure, when data recording is occurred during the intermediate adjusting processes, it is possible to omit the processes in which the intermediate adjusting processes are interrupted temporarily and the data recording is performed (corresponding to S16-S18 in FIG. 5).

Also, in the example above, the multilayer optical disk D with the dual layer structure is exemplified, but the invention can be applied to a multilayer optical disk (including a rewritable DVD±RW etc.) having equal to or more than three layers and a multilayer information recording medium in addition to the multilayer optical disk. Further, the invention can shorten the initialization time to a same extent as that of the single structure regardless of the number of the recording layers. Therefore, the more the recording layers are laminated, the better the advantage can be obtained.

In the example above, the intermediate adjusting processes are performed during the “power save mode” in the intermittent motion. It is also possible to perform the intermediate adjusting processes by using a tiny non-recording motion time during the information recording process after the start of information recording, not limiting to the power save mode. It is possible to perform the intermediate adjusting processes by interrupting the recording motion temporarily, though recording time could be affected to a certain degree. Also, the intermediate adjusting processes may be performed during which the user starts a next information recording process after the completion of information recording.

Also, it is possible to provide each device and each function of the DVD camcorder 1 described above as a program. Further, it is possible to provide the program which is stored in a recording medium (not shown). As recording media, CD-ROM, flash ROM, memory cards (e.g., Compact Flash [registered trademark], Smart Media, Memory Stick), Compact Discs, magneto-optical disks, digital versatile discs, flexible disks and hard disks may be used.

Also, in addition to the above embodiment, it is possible to modify the structure of the apparatus and processing steps appropriately without departing from the scope of the invention. The intermediate adjusting process function of the invention can be provided in BD (Blue-ray Disk) camcorders and DVD recorders which are capable of recording on multilayer information recording media, in addition to the DVD camcorder 1.

1. An information recording apparatus comprising:
an adjusting process device which performs adjusting processes including an OPC process for optimizing a recording power for each of recording layers on a multilayer information recording medium, and
an information recording device which performs an information recording process for each of the recording layers based on a result of the adjusting processes for each of the recording layers,
the adjusting process device including:
an initial adjusting process device which performs the adjusting processes at a start of information recording with the information recording device only for a start recording layer having a first recording start address, and
an intermediate adjusting process device which performs the adjusting processes during information recording process with the information recording device for a recording layer other than the start recording layer.

2. The information recording apparatus according to claim 1, wherein the information recording device performs the information recording process with an intermittent motion repeating a real recording motion mode and a power save mode, and the intermittent adjusting process device performs the adjusting processes in the power save mode.

3. The information recording apparatus according to claim 2, wherein the intermediate adjusting process device interrupts the adjusting process to switch the information recording device to the real recording motion mode in a case that the information recording device needs to be switched to the real recording motion mode during the adjusting processes, and performs incomplete adjusting processes when the information recording device is switched to the power save mode again.

4. The information recording apparatus according to claim 2, wherein the intermediate adjusting process device performs partial adjusting processes divided into a plurality of processes from the adjusting processes when the information recording device is switched from the real recording motion mode to the power save mode.

5. A method of an OPC process for a multilayer information recording medium which performs the OPC process for optimizing a recording power for each of recording layers on the multilayer information recording medium, the OPC process being performed during an information recording process for a recording layer other than a start recording layer having a first recording start address.

6. A program which causes a computer to function as each of the devices in the information recording apparatus according to claim 1.

7. A program which causes a computer to function as each of the devices in the information recording apparatus according to claim 2.

8. A program which causes a computer to function as each of the devices in the information recording apparatus according to claim 3.

9. A program which causes a computer to function as each of the devices in the information recording apparatus according to claim 4.
